(19) United States
(12) Patent Application Publication
(10) Pub. No.: US 2018/0362735 A1
(43) Pub. Date: Dec. 20, 2018

(54) SOLVENT EXCHANGE COMPOSITIONS

(71) Applicant: SAPPI Netherlands Services B.V., Maastricht (NL)

(72) Inventors: Wim BALLET, Riemst (BE); Seda CANTEKIN, Maastricht (NL); Gustavo DUARTE, Maastricht (NL); Saschi MOMIN, London (GB); Jo SIMONS, Maaseik (BE)

(73) Assignee: SAPPI Netherlands Services B.V., Maastricht (NL)

(21) Appl. No.: 15/736,811

(22) PCT Filed: Jun. 16, 2016
(86) PCT No.: PCT/EP2016/063916

§ 371 Date: Dec. 15, 2017

(30) Foreign Application Priority Data
Jun. 17, 2015 (EP) 15172621.3

(51) Int. Cl. C08L 1/02; C08J 3/09; C08J 3/12

(52) U.S. Cl. CPC C08L 1/02; C08J 3/09; C08J 2301/02; C08L 2201/56; C08J 3/12

(57) ABSTRACT

The present invention provides for a dispersion containing cellulose particles dispersed in a continuous liquid phase comprising a first and a second continuous liquid phase, wherein the first continuous liquid phase consists of a liquid swelling agent or an aqueous solution of said liquid swelling agent, and the second continuous liquid phase comprises, preferably consists of, one or more organic solvents, with the proviso that the one or more organic solvents of the second continuous liquid phase are not capable of dissolving cellulose, have a boiling point higher than the boiling point of the first continuous liquid phase, and are miscible with the constituents of the swelling composition.

### TECHNICAL FIELD

The present invention relates to dispersions containing cellulose particles dispersed in a continuous liquid phase suitable in particular for use in a method to exchange the continuous liquid phase of such a dispersion for a different continuous liquid phase.

### PRIOR ART

Nanocellulose is a promising material which has recently benefited from increased scrutiny in the industry for multiple applications such as fiber production, polymer reinforcement and medical uses. Currently, two main production processes exist for obtaining nanocellulose; the first is based on milling and fluidization in aqueous solutions, where nanocellulose is obtained from a process which is based on the traditional pulping process. This process usually results in a diluted aqueous dispersion containing a small amount of nanocellulose particles in an aqueous solution. However, dilute dispersions such as these are not of much interest in an industrial context since they are of high volume but contain little amounts of the material of interest, and thus it seems logical that the industry would seek either dispersions having a higher concentration of nanocellulose or even pure, dried nanocellulose.

In order to yield dried nanocellulose, it is therefore desirable to develop a process that allows the removal of the aqueous solution to produce a more convenient, dried powder of nanocellulose. However, it has been found that upon removal by evaporation of the aqueous solution of such dispersions, in the obtained nanocellulose powder microscopic agglomerates are formed which cannot be re-dispersed in an aqueous liquid without considerable effort (so-called hornification), or even not at all. In the past, this has been remediated by adding additives that somehow hinder aggregation, but the problem is that these additives cling to the nanocellulose powder because they cannot be easily removed and are seen as contaminants.

The formation of these un-dispersible agglomerates in the nanocellulose powder is thought to be the main reason for the loss of some of the desirable mechanical properties of the thus dried nanocellulose when the thus dried nanocellulose powder is rehydrated with water for further processing, and one must revert to the dilute dispersions of never-dried nanocellulose.

These disadvantages strongly impede the more widespread use of nanocellulose, since dilute dispersions cannot be transported in an acceptable manner and less-than optimal mechanical properties, coupled to dispersion problems, make the thus obtained dried nanocellulose powders unattractive.

In fact, most nanocellulose is nowadays freshly produced ad hoc and immediately used in the form of a dispersion, without ever having been dried and re-hydrated.

Therefore, it is highly desirable to provide means that enable the production of a dry, convenient form of nanocellulose which can easily be stored and transported and re-dispersed in water or other aqueous liquids without losing any beneficial properties, and which means take advantage of pre-existing industrial infrastructure and that which allow to be used preferably immediately downstream of existing production processes of nanocellulose.

U.S. Pat. No. 4,481,076 A1 discloses re-dispersible, microfibrillated cellulose which is obtained by adding an additive compound to an aqueous dispersion of microfibrillated cellulose, and then drying by for example spray drying without exchanging solvents. The additive compound can be triethanol amine, ethylene glycol or propylene glycol.

CH 419592 A1 discloses a process in which an aqueous colloidal dispersion is combined with an agent that hinders re-aggregation during drying, and then drying without any exchange of solvents.

U.S. Pat. No. 6967027 B1 relates to non-flocculent dispersions of cellulose microcrystals and/or microfibrils, which do not flocculate when introduced into organic solvents. This is achieved by the use of a compound having a hydrophilic part and a hydrophobic part, such as for example a surfactant, or a mixture of a surfactant and a co-surfactant without any exchange of solvents.

JPS 5082144 teaches adding polyethylene glycol and diamines to a suspension of cellulose in order to stabilize it.

### SUMMARY OF THE INVENTION

The present invention provides a dispersion of cellulose particles which remedies the aforementioned drawbacks of the state of the art and which dispersion can be used to produce a dry form of nanocellulose which is fully re-dispersible in aqueous solutions or water.

The term “swelling agent” is defined as being an agent that can disrupt either the intercrystalline bonding or which can disrupt both the intercrystalline and partially (but not fully) the intracrystalline bonding normally present in cellulosic material. Agents that will only disrupt intercrystalline bonding (and at most will minimally affect intracrystalline structure), will only lead to swelling independent of the reaction conditions used. Such agents will never lead to full solvation (which is a result of significant or full disruption of intracrystalline bonding) of the cellulosic material. The extent of swelling is dependent on the interaction conditions.

The term “nanofibrillated cellulose” refers to cellulose particles which are characterized by having an elongated form, having an aspect ratio of >1, and having an average length in the range of 15-900 nm or 15-1500 nm or 900-1500 nm, preferably in the range of 50-700 nm, more preferably 70-700nm. The average thickness is preferably in the range of 3-200 nm, preferably in the range of 5-100 nm, more preferably in the range of 5-30 nm (for example, see FIG. 1(A).

The present invention provides for a dispersion containing cellulose particles dispersed in a continuous liquid phase comprising a first and a second continuous liquid phase, wherein
the first continuous liquid phase consists of a liquid swelling agent or an aqueous solution of said liquid swelling agent, and
the second continuous liquid phase comprises, preferably consists of, one or more organic solvents, with the proviso that the one or more organic solvents of the second continuous liquid phase
   i. are not capable of dissolving cellulose,
   ii. have a boiling point higher than the boiling point of the first continuous liquid phase, and
   iii. are miscible with the constituents of the swelling composition.

In yet a further embodiment, the present invention provides for the use of any of the above dispersions in a method to exchange the continuous liquid phase of a dispersion for a different continuous liquid phase or for the use of any of the above dispersions in a method to produce a dry powder of nanocellulose that can be re-dispersed in an aqueous solvent or in water, preferably essentially without the formation of nanocellulose aggregates.

In another embodiment, the present invention provides for method to exchange the continuous liquid phase of a dispersion for a different continuous liquid phase, comprising the steps of:

a. providing a predetermined amount of a dispersion containing cellulose particles dispersed in a first continuous liquid phase,
b. adding a predetermined amount of a second continuous liquid phase to the dispersion containing cellulose particles dispersed in a first continuous liquid phase such as to form a dispersion containing cellulose particles dispersed in a mixture of first and second continuous liquid phase,
c. removing the first continuous liquid phase from the dispersion containing cellulose particles dispersed in a mixture of first and second continuous liquid phase by evaporation to form a dispersion containing cellulose particles dispersed in a second continuous liquid phase,
d. optionally removing a part of the second continuous liquid phase from the dispersion containing cellulose particles dispersed in a second continuous liquid phase by evaporation to form a dispersion containing a increased concentration of cellulose particles dispersed in a second continuous liquid phase,
e. isolating the dispersion containing cellulose particles dispersed in a second continuous liquid phase or the dispersion containing an increased concentration of cellulose particles dispersed in a second continuous liquid phase, wherein
the first continuous liquid phase consists of a liquid swelling agent or an aqueous solution of said liquid swelling agent, and
the second continuous liquid phase comprises, preferably consists of, one or more organic solvents, with the proviso that the one or more organic solvents of the second continuous liquid phase
   i. are not capable of dissolving cellulose,
   ii. have a boiling point higher than the boiling point of the first continuous liquid phase, and

iii. are miscible with the constituents of the swelling composition.

In another embodiment, the present invention provides for a method to produce a dry powder of nanocellulose that can be re-dispersed in an aqueous solvent or in water, comprising the above method of exchanging the continuous liquid phase of a dispersion of cellulose particles for a different continuous liquid phase and further comprising the steps of
f. removing the second continuous liquid phase from the dispersion containing cellulose particles dispersed in a second continuous liquid phase or the dispersion containing an increased concentration of cellulose particles dispersed in a second continuous liquid phase to form a dry powder of nanocellulose that can be re-dispersed in an aqueous solvent or in water.

Further embodiments of the invention are laid down in the dependent claims.

### DESCRIPTION OF PREFERRED EMBODIMENTS

The present invention provides for a dispersion containing cellulose particles dispersed in a continuous liquid phase comprising a first and a second continuous liquid phase, wherein
the first continuous liquid phase consists of a liquid swelling agent or an aqueous solution of said liquid swelling agent, and
the second continuous liquid phase comprises, preferably consists of, one or more organic solvents, with the proviso that the one or more organic solvents of the second continuous liquid phase
   i. are not capable of dissolving cellulose,
   ii. have a boiling point higher than the boiling point of the first continuous liquid phase, and
   iii. are miscible with the constituents of the swelling composition.

This dispersion has several advantages that make this dispersion useful when preparing a dry powder of nanocellulose that can be re-dispersed in an aqueous solvent or in water: The removal of the first continuous liquid phase can be achieved easily by heating the dispersion, either under atmospheric pressure or pressure below atmospheric pressure to essentially drive off all of the first continuous liquid phase, in a classic distillation apparatus. This has the advantage that the first continuous liquid phase can be re-used as-is in the process that yields a dispersion of nanocellulose dispersed in the first continuous liquid phase and that the remaining dispersion of nanocellulose in the second continuous liquid phase is essentially free of first continuous liquid phase that might otherwise negatively influence the subsequent process step of drying the dispersion of nanocellulose in the second continuous liquid phase and cause hornification. The use of the dispersion for exchanging the continuous liquid phase avoids the use of more complex solvent exchange processes in which the first continuous liquid phase is progressively washed away by large amounts of second continuous liquid phase in a centrifugal filtering device equipped with a membrane adapted to retain the cellulose particles but allow the first continuous liquid phase to get washed away. Also, an advantage is that the dispersion can be quickly heated to remove the first continuous liquid phase, in contrast to time-intensive methods in which a dialysis membrane is used to exchange the solvent over a period of weeks or more.

The term “essentially free of first continuous liquid phase” means that there is less than 1% (by volume), preferably less than 0.5% (by volume) of first continuous liquid phase.

In another embodiment, the present invention provides for a dispersion wherein the one or more organic solvents of the second continuous liquid phase are one or more alcohols, preferably one or more polyols, more preferably one or more diols such as ethylene glycol or propylene glycol. Exemplary alcohols that can be used as organic solvents of the second continuous liquid phase are linear or branched C4-C6 or C4-C8 or C6-C8 alcohols such as 1-pentanol, 3-methyl-1-pentanol, 4-methyl-1-pentanol, 1-hexanol, 2-hexanol, 3-hexanol, 2-ethyl-1-hexanol, 2 2,3-dimethyl-1-butanol, 3,3-dimethyl-1-butanol, 2-ethyl-1-butanol, 2-methyl-1-pentanol, 2,2-dimethyl-1-butanol, 4-methyl-2-pentanol; cyclic alcohols such as cyclopentanol, cyclohexanol; diols such as ethylene glycol, 1,3-propanediol, 1,2-propanediol, 1,2-butanediol and 2,3-butanediol. Preferred alcohols are alkyl-1-hexanol, where in particular the alkyl corresponds to methyl or ethyl, such as for example 2-ethyl-1-hexanol.

The choice of alcohol will depend on the ensuing drying process into which the dispersion containing cellulose particles dispersed in the second continuous liquid phase is led, since the chemical nature of the alcohol can influence the performance of the ensuing drying process. As an exemplary combination, when the drying process is spray drying or spray drying with a fluid in a critical or supercritical state, particularly preferred organic alcohols are branched C4-C8 alcohols such as 2-ethyl-1-hexanol, diols like ethylene glycol, 1,3-propanediol, 1,2-propanediol or cyclic alcohols like cyclohexanol or cyclopentanol.

In yet another embodiment, the present invention provides for a dispersion wherein the first continuous liquid phase consists of a an aqueous solution of liquid swelling agent, and the liquid swelling agent is chosen from cyclic or heterocyclic amines, aliphatic secondary amines, aliphatic tertiary amines, ionic liquids, urea, or ammonia. An exemplar

In a further embodiment, the present invention provides for a dispersion wherein the first continuous liquid phase consists of an aqueous solution of morpholine, piperidine or both, and more preferably of an aqueous solution of morpholine, piperidine or both comprising of from 60 to 99% (by volume) of morpholine, piperidine or both, or of from 70 to 95% (by volume) of morpholine or piperidine or both, the remaining % (by volume) being made up of water.

In yet another embodiment, the present invention provides for a dispersion wherein said dispersion comprises up to 20% (by weight), preferably of from 0.1 to 20% (by weight), more preferably of from 0.1 to 5% (by weight) of cellulose particles.

In yet a further embodiment, the present invention provides for a dispersion wherein the cellulose particles are nanocellulose particles such as nanofibrillated cellulose (NFC) particles or cellulose nanocrystal (CNC) particles, and more preferably are particles of non-derivatized nanocellulose.

The present invention also provides for the use of any of the above dispersions in a method to exchange the continuous liquid phase of a dispersion for a different continuous liquid phase or for the use of any of the above dispersions in a method to produce a dry powder of nanocellulose that can be re-dispersed in an aqueous solvent or in water, preferably essentially without the formation of nanocellulose aggregates.

The present invention further provides for a method to exchange the continuous liquid phase of a dispersion for a different continuous liquid phase, comprising the steps of:

a. providing a predetermined amount of a dispersion containing cellulose particles dispersed in a first continuous liquid phase,
b. adding a predetermined amount of a second continuous liquid phase to the dispersion containing cellulose particles dispersed in a first continuous liquid phase such as to form a dispersion containing cellulose particles dispersed in a mixture of first and second continuous liquid phase,
c. removing the first continuous liquid phase from the dispersion containing cellulose particles dispersed in a mixture of first and second continuous liquid phase by evaporation to form a dispersion containing cellulose particles dispersed in a second continuous liquid phase,
d. optionally removing a part of the second continuous liquid phase from the dispersion containing cellulose particles dispersed in a second continuous liquid phase by evaporation to form a dispersion containing a increased concentration of cellulose particles dispersed in a second continuous liquid phase,
e. isolating the dispersion containing cellulose particles dispersed in a second continuous liquid phase or the dispersion containing an increased concentration of cellulose particles dispersed in a second continuous liquid phase, wherein
the first continuous liquid phase consists of a liquid swelling agent or an aqueous solution of said liquid swelling agent, and
the second continuous liquid phase comprises, preferably consists of, one or more organic solvents, with the proviso that the one or more organic solvents of the second continuous liquid phase
   i. are not capable of dissolving cellulose,
   ii. have a boiling point higher than the boiling point of the first continuous liquid phase, and
   iii. are miscible with the constituents of the swelling composition.

An advantage of the method is that it can be carried out in pre-existing industrial infrastructure such as a large-scale distillation device, i.e. not necessarily on more specific and expensive installations such as preparative centrifuges and such or through dialysis.

In another embodiment of the present invention, the method to exchange the continuous liquid phase of a dispersion for a different continuous liquid phase, the removal by evaporation of the first continuous liquid phase is carried out at a pressure of less than 1 atm, preferably at a pressure of from 0.1 atm to 0.9 atm and at a temperature of below 240° C., preferably at a temperature of from 140° C. to 200° C., more preferably of from 150° C. to 190° C.

Increasing the temperature above 240° C., or even 200° C. for a prolonged time will likely result in the thermal degradation of the cellulose particles, whereas temperatures of 140° and above will generally be necessary to evaporate the first continuous liquid phase under atmospheric pressure and below. It is further possible to evaporate the first continuous liquid phase under reduced atmospheric pressure of less than 60 mbar or from 10 to 60 mbar and even more preferably of less than 30 mbar or from 10 to 30 mbar. At pressure of less than 60 mbar, the evaporation of the first continuous liquid phase can be carried out at a temperature of less than 140° C. or 70-140° C., and is preferably carried out at a temperature of less than 100° C. or 70-100° C. In a preferred embodiment, removing the first continuous liquid phase from the dispersion containing cellulose particles dispersed in a mixture of first and second continuous liquid phase by evaporation to form a dispersion containing cellulose particles dispersed in a second continuous liquid phase is carried out at a pressure of less than 30 mbar or from 10 to 30 mbar and at a temperature of less than 100° C. or 70-100° C., in particular when the second continuous liquid comprises, or essentially consists of alkyl-1-hexanol, where in particular the alkyl corresponds to methyl or ethyl, such as for example 2-ethyl-1-hexanol.

In another embodiment of the method to exchange the continuous liquid phase of a dispersion for a different continuous liquid phase, the one or more organic solvents of the second continuous liquid phase are one or more alcohols, preferably one or more polyols, more preferably one or more diols such as ethylene glycol or propylene glycol and/or the first continuous liquid phase consists of a an aqueous solution of liquid swelling agent, and the liquid swelling agent is chosen from cyclic or heterocyclic amines, aliphatic secondary amines, aliphatic tertiary amines, ionic liquids, urea, or ammonia.

In another embodiment of the method to exchange the continuous liquid phase of a dispersion for a different continuous liquid phase, the cellulose particles are nanocellulose particles such as nanofibrillated cellulose (NFC) particles or cellulose nanocrystals (CNC) particles, and more preferably particles of non-derivatized nanocellulose and/or the dispersion containing cellulose particles dispersed in a first continuous liquid phase comprises up to 20% (by weight), preferably of from 0.1 to % (by weight), more preferably of from 0.1 to 5% (by weight) of cellulose particles

The present invention further provides for a method to produce a dry powder of nanocellulose that can be re-dispersed in an aqueous solvent or in water, comprising the method of exchanging the continuous liquid phase of a dispersion of cellulose particles for a different continuous liquid phase of above and further comprising the steps of

f. removing the second continuous liquid phase from the dispersion containing cellulose particles dispersed in a second continuous liquid phase or the dispersion containing an increased concentration of cellulose particles dispersed in a second continuous liquid phase to form a dry powder of nanocellulose that can be re-dispersed in an aqueous solvent or in water.

In another embodiment, the method to produce a dry powder of nanocellulose, the removal of the second continuous liquid phase is carried out by evaporating the second continuous liquid phase either in a spray-drying process or spray-drying using a supercritical fluid, such as supercritical carbon dioxide. Each of the spray-drying techniques yields a freely flowable, particulate material well-suited for further use in an industrial process.

1. A dispersion containing cellulose particles dispersed in a continuous liquid phase comprising a mixture of a first and a second continuous liquid phase, wherein
the first continuous liquid phase consists of a liquid swelling agent or an aqueous solution of said liquid swelling agent, and
the second continuous liquid phase comprises one or more organic solvents, with the proviso that the one or more organic solvents of the second continuous liquid phase
i. are not capable of dissolving cellulose,
ii. have a boiling point higher than the boiling point of the constituents of the first continuous liquid phase, and
iii. are freely miscible with the constituents of the swelling composition.

2. The dispersion according of claim 1, wherein the one or more organic solvents of the second continuous liquid phase are one or more alcohols.

3. The dispersion according of claim 1, wherein the first continuous liquid phase consists of a an aqueous solution of liquid swelling agent, and the liquid swelling agent is chosen from cyclic amines, heterocyclic amines, aliphatic secondary amines, aliphatic tertiary amines, ionic liquids, urea, and ammonia.

4. The dispersion according to claim 1, wherein the first continuous liquid phase consists of an aqueous solution of morpholine, piperidine or both.

5. The dispersion according to claim 1, wherein it comprises up to 20% (by weight) of cellulose particles.

6. The dispersion according to claim 1, wherein the cellulose particles are nanocellulose particles.

7. (canceled)

8. A method to exchange the continuous liquid phase of a dispersion of cellulose particles for a different continuous liquid phase, comprising the steps of:
a. providing an amount of a dispersion containing cellulose particles dispersed in a first continuous liquid phase,
b. adding an amount of a second continuous liquid phase to the dispersion containing cellulose particles dispersed in a first continuous liquid phase such as to form a dispersion containing cellulose particles dispersed in a mixture of first and second continuous liquid phase,
c. removing the first continuous liquid phase from the dispersion containing cellulose particles dispersed in a mixture of first and second continuous liquid phase by evaporation to form a dispersion containing cellulose particles dispersed in a second continuous liquid phase,
d. removing a part of the second continuous liquid phase from the dispersion containing cellulose particles dispersed in a second continuous liquid phase by evaporation to form a dispersion containing an increased concentration of cellulose particles dispersed in a second continuous liquid phase,
e. isolating the dispersion containing an increased concentration of cellulose particles dispersed in a second continuous liquid phase, wherein
the first continuous liquid phase consists of a liquid swelling agent or an aqueous solution of said liquid swelling agent, and
the second continuous liquid phase comprises, one or more organic solvents,
with the proviso that the one or more organic solvents of the second continuous liquid phase
i. are not capable of dissolving cellulose,
ii. have a boiling point higher than the boiling point of the constituents of the first continuous liquid phase, and
iii. are freely miscible with the constituents of the swelling composition.

9. The method to exchange the continuous liquid phase of a dispersion for a different continuous liquid phase according to claim 8, wherein the removal by evaporation of the first continuous liquid phase is carried out at a pressure of less than 60 mbar and at a temperature of less than 140° C.

10. The method to exchange the continuous liquid phase of a dispersion for a different continuous liquid phase according to claim 8, wherein the one or more organic solvents of the second continuous liquid phase are one or more alcohols and the first continuous liquid phase consists of a an aqueous solution of liquid swelling agent, and the liquid swelling agent is chosen from cyclic amines, heterocyclic amines, aliphatic secondary amines, aliphatic tertiary amines, ionic liquids, urea, and ammonia.

11. The method to exchange the continuous liquid phase of a dispersion for a different continuous liquid phase according to claim 8, wherein the cellulose particles are nanocellulose particles and the dispersion containing cellulose particles dispersed in a first continuous liquid phase comprises up to 20% (by weight).

12. A method to produce a dry powder of nanocellulose that can be re-dispersed in an aqueous solvent or in water, comprising: the steps of the method of exchanging the continuous liquid phase of a dispersion of cellulose particles for a different continuous liquid phase according to claim 8, and further comprising the steps of
f. removing the second continuous liquid phase from the dispersion containing cellulose particles dispersed in a second continuous liquid phase or the dispersion containing an increased concentration of cellulose particles dispersed in a second continuous liquid phase to form a dry powder of nanocellulose that can be re-dispersed in an aqueous solvent or in water.

13. The method to produce a dry powder of nanocellulose according to claim 12, wherein the removal of the second continuous liquid phase is carried out by evaporating the second continuous liquid phase either in a spray-drying process or spray-drying using a supercritical fluid, such as supercritical carbon dioxide.

14. The dispersion according of claim 1, wherein the second continuous liquid phase consists of one or more organic solvents.

15. The dispersion according of claim 1, wherein the one or more organic solvents of the second continuous liquid phase are one or more polyols or alkyl-1-hexanol.

16. The dispersion according of claim 1, wherein the one or more organic solvents of the second continuous liquid phase are methyl-1-hexanol or ethyl-1-hexanol or ethylene glycol or propylene glycol.

17. The dispersion according to claim 1, wherein the first continuous liquid phase consists of an aqueous solution of morpholine, piperidine or both comprising of from 60 to 99% (by volume) of morpholine, piperidine or both, the remaining % (by volume) being made up of water.

18. The dispersion according to claim 1, wherein the first continuous liquid phase consists of an aqueous solution of morpholine, piperidine or both comprising of from 70 to 95% (by volume) of morpholine, piperidine or both, the remaining % (by volume) being made up of water.

19. The dispersion according to claim 1, wherein it comprises of from 0.1 to 20% (by weight) of cellulose particles.

20. The dispersion according to claim 1, wherein it comprises of from 0.1 to 5% (by weight) of cellulose particles.

21. The dispersion according to claim 1, wherein the cellulose particles are nanofibrillated cellulose (NFC) particles or cellulose nanocrystals (CNC) particles.

22. The dispersion according to claim 1, wherein the cellulose particles are of non-derivatized nanocellulose particles.

23. The dispersion according to claim 1, wherein the cellulose particles are of non-derivatized nanofibrillated cellulose (NFC) particles or of non-derivatized cellulose nanocrystals (CNC) particles.

24. A method to exchange the continuous liquid phase of a dispersion of cellulose particles for a different continuous liquid phase, comprising the steps of:
a. providing an amount of a dispersion containing cellulose particles dispersed in a first continuous liquid phase,
b. adding an amount of a second continuous liquid phase to the dispersion containing cellulose particles dispersed in a first continuous liquid phase such as to form a dispersion containing cellulose particles dispersed in a mixture of first and second continuous liquid phase,
c. removing the first continuous liquid phase from the dispersion containing cellulose particles dispersed in a mixture of first and second continuous liquid phase by evaporation to form a dispersion containing cellulose particles dispersed in a second continuous liquid phase,
d. isolating the dispersion containing cellulose particles dispersed in a second continuous liquid phase, wherein:
the first continuous liquid phase consists of a liquid swelling agent or an aqueous solution of said liquid swelling agent, and
the second continuous liquid phase comprises one or more organic solvents, with the proviso that the one or more organic solvents of the second continuous liquid phase:
i. are not capable of dissolving cellulose,
ii. have a boiling point higher than the boiling point of the constituents of the first continuous liquid phase, and
iii. are freely miscible with the constituents of the swelling composition.

25. The method according of claim 8, wherein the second continuous liquid phase consists of one or more organic solvents.

26. The method according of claim 8, wherein the one or more organic solvents of the second continuous liquid phase are one or more polyols or alkyl-1-hexanol.

27. The method according of claim 8, wherein the one or more organic solvents of the second continuous liquid phase are is methyl-1-hexanol or ethyl-1-hexanol or ethylene glycol or propylene glycol.

28. The method according of claim 8, wherein the first continuous liquid phase consists of an aqueous solution of morpholine, piperidine or both comprising of from 60 to 99% (by volume) of morpholine, piperidine or both, the remaining % (by volume) being made up of water.

29. The method according of claim 8, wherein the first continuous liquid phase consists of an aqueous solution of morpholine, piperidine or both comprising of from 70 to 95% (by volume) of morpholine, piperidine or both, the remaining % (by volume) being made up of water.

30. The method according of claim 8, wherein the dispersion containing cellulose particles dispersed in a first continuous liquid phase comprises of from 0.1 to 20% (by weight) of cellulose particles.

31. The method according of claim 8, wherein the dispersion containing cellulose particles dispersed in a first continuous liquid phase comprises of from 0.1 to 5% (by weight) of cellulose particles.

32. The method according of claim 8, wherein the cellulose particles are nanofibrillated cellulose (NFC) particles or cellulose nanocrystals (CNC) particles.

33. The method according of claim 8, wherein the cellulose particles are of non-derivatized nanocellulose.

34. The method according of claim 8, wherein the cellulose particles are of non-derivatized nanofibrillated cellulose (NFC) particles or of non-derivatized cellulose nanocrystals (CNC) particles.

35. The method according of claim 24, wherein the second continuous liquid phase consists of one or more organic solvents.

36. The method according of claim 24, wherein the one or more organic solvents of the second continuous liquid phase are one or more polyols or alkyl-1-hexanol.

37. The method according of claim 24, wherein the one or more organic solvents of the second continuous liquid phase are methyl-1-hexanol or ethyl-1-hexanol or ethylene glycol or propylene glycol.

38. The method according of claim 24, wherein the first continuous liquid phase consists of an aqueous solution of morpholine, piperidine or both comprising of from 60 to 99% (by volume) of morpholine, piperidine or both, the remaining % (by volume) being made up of water.

39. The method according of claim 24, wherein the first continuous liquid phase consists of an aqueous solution of morpholine, piperidine or both comprising of from 70 to 95% (by volume) of morpholine, piperidine or both, the remaining % (by volume) being made up of water.

40. The method according of claim 24, wherein the dispersion containing cellulose particles dispersed in a first continuous liquid phase comprises of from 0.1 to 20% (by weight) of cellulose particles.

41. The method according of claim 24, wherein the dispersion containing cellulose particles dispersed in a first continuous liquid phase comprises of from 0.1 to 5% (by weight) of cellulose particles.

42. The method according of claim 24, wherein the cellulose particles are nanofibrillated cellulose (NFC) particles or cellulose nanocrystals (CNC) particles.

43. The method according of claim 24, wherein the cellulose particles are of non-derivatized nanocellulose particles.

44. The method according of claim 24, wherein the cellulose particles are of non-derivatized nanofibrillated cellulose (NFC) particles or of non-derivatized cellulose nanocrystals (CNC) particles.

45. The method to produce a dry powder of nanocellulose according to claim 12, wherein the removal of the second continuous liquid phase is carried out by evaporating the second continuous liquid phase either in a spray-drying process or spray-drying using supercritical carbon dioxide.
